(19) United States
(12) Patent Application Publication
(10) Pub. No.: US 2015/0269450 A1
(43) Pub. Date: Sep. 24, 2015

(54) MOBILE BODY OPERATION SUPPORT DEVICE, MOBILE BODY OPERATION SUPPORT METHOD, AND COMPUTER READABLE NON-TRANSITORY STORAGE MEDIUM COMPRISING MOBILE BODY OPERATION SUPPORT PROGRAM

(71) Applicant: KABUSHIKI KAISHA TOSHIBA, Tokyo (JP)

(72) Inventor: Tsuyoshi Tasaki, Yokohama (JP)

(21) Appl. No.: 14/642,923

(22) Filed: Mar. 10, 2015

(30) Foreign Application Priority Data
Mar. 24, 2014 (JP) 2014-060021

(51) Int. Cl. G06K 9/00; G06T 7/00; B60R 1/00; H04N 7/18

(52) U.S. Cl. CPC G06K 9/00805; H04N 7/185; G06T 7/004; B60R 1/00; B60R 2300/8093

(57) ABSTRACT

According to one embodiment, a mobile body operation support device includes a measurement point selection section acquiring a point on an object around a mobile body when distance from an endpoint representing a position on a surface of the mobile body to the point on the object falls within a measurement range setting from a constraint of a movement range of the mobile body.

### CROSS-REFERENCE TO RELATED APPLICATION

This application is based upon and claims the benefit of priority from Japanese Patent Application No. 2014-060021, filed on Mar. 24, 2014; the entire contents of which are incorporated herein by reference.

### FIELD

Embodiments described herein relate generally to a mobile body operation support device, a mobile body operation support method, and a computer readable non-transitory storage medium comprising a mobile body operation support program.

### BACKGROUND

There has been proposed a method for superimposing distance information from a vehicle-mounted sensor on a look-down image. However, it is difficult to determine which part of the mobile body will collide with which position of a surrounding object simply by superimposing the distance information from the sensor on the look-down image.

### BRIEF DESCRIPTION OF THE DRAWINGS

FIG. 1 is a block diagram showing an example of a configuration of a mobile body operation support system of an embodiment;

FIG. 2A and FIG. 2B are schematic views for explaining to set an endpoint of the embodiment;

FIG. 3A and FIG. 3B are schematic views for explaining to set an endpoint of the embodiment;

FIG. 4 is schematic view for explaining to set the endpoint of an embodiment;

FIG. 5A and FIG. 5B are schematic views for explaining to set a measurement range of the embodiment;

FIG. 6A and FIG. 6B are schematic views for explaining to set a measurement range of the embodiment;

FIG. 7A and FIG. 7B are schematic views for explaining to set a measurement range of the embodiment;

FIG. 8A and FIG. 8B are schematic views showing an example of an image display of the embodiment; and

FIG. 9A and FIG. 9B are schematic views showing an example of an image display of the embodiment.

### DETAILED DESCRIPTION

According to one embodiment, a mobile body operation support device includes a measurement point selection section acquiring a point on an object around a mobile body when distance from an endpoint representing a position on a surface of the mobile body to the point on the object falls within a measurement range setting from a constraint of a movement range of the mobile body.

Embodiments will now be described with reference to the drawings. In the drawings, like components are labeled with like reference numerals.

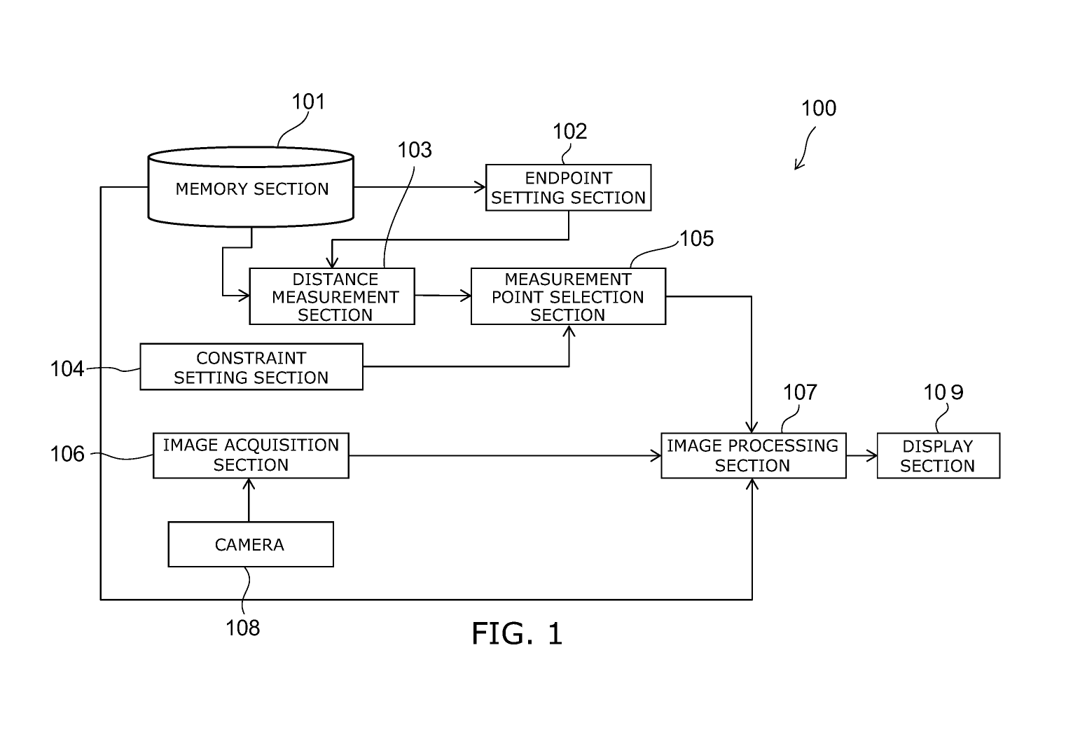

FIG. 1 is a block diagram showing an example of the configuration of a mobile body operation support system 100 of an embodiment.

The mobile body operation support system 100 of the embodiment supports the operator's operation of a mobile body (operation target). The mobile body is e.g. an automobile such as a two-wheel motor vehicle and four-wheel motor vehicle, a flying body, or a remote-controlled robot.

The mobile body operation support system 100 includes a memory section 101, an endpoint setting section 102, a distance measurement section 103, a constraint setting section 104, a measurement point selection section 105, an image acquisition section 106, an image processing section 107, a camera 108, and a display section 109.

The camera 108 and the distance measurement section 103 are mounted on the mobile body. In the case where the mobile body is a remote-controlled robot or flying body operated wirelessly, the captured data of the camera 108 and the measurement data of the distance measurement section 103 mounted on the mobile body are wirelessly transmitted to a controller-side unit. In the case where image acquisition and processing can be performed inside the mobile body, the result of image processing may be transmitted to the controller-side unit.

The display section 109 is e.g. a display for displaying input and output data for the mobile body operation support system 100. The display section 109 is installed at a position where the operator can view it during the operation of the mobile body. In the case where the mobile body is e.g. an automobile or flying body which the operator is on board, the display section 109 is mounted on the mobile body. In the case where the mobile body is a remote-controlled robot or flying body, the display section 109 is installed on the controller-side unit.

The memory section 101, the endpoint setting section 102, the constraint setting section 104, the measurement point selection section 105, the image acquisition section 106, and the image processing section 107 are mounted on the mobile body in the case where the mobile body is e.g. an automobile or flying body which the operator is on board.

The memory section 101, the endpoint setting section 102, the constraint setting section 104, the measurement point selection section 105, the image acquisition section 106, and the image processing section 107 can be mounted on the mobile body or installed on the controller-side unit in the case of a remote-controlled robot or flying body.

The endpoint setting section 102, the constraint setting section 104, the measurement point selection section 105, the image acquisition section 106, and the image processing section 107 are formed in the form of a semiconductor device such as an IC (integrated circuit) chip and constitute the mobile body operation support device of the embodiment.

The memory section 101 is e.g. a magnetic disk or semiconductor memory. The memory section 101 stores shape data of the mobile body. The shape data includes constituent point data indicating the three-dimensional model of the mobile body. The constituent point data can be based on vertices of a polygon used in a typical three-dimensional CG (computer graphics) model.

The memory section 101 further stores data representing the installation position and posture of the distance measurement section 103 on the mobile body.

The shape data may include surface data formed from a plurality of constituent points besides the constituent point data. The surface data can be based on polygons used in a typical CG model.

The memory section 101 also stores data representing the installation position and posture of the camera 108 for image acquisition on the mobile body.

The endpoint setting section 102 extracts as an endpoint the three-dimensional position on the mobile body coordinate system of the constituent point stored in the memory section 101.

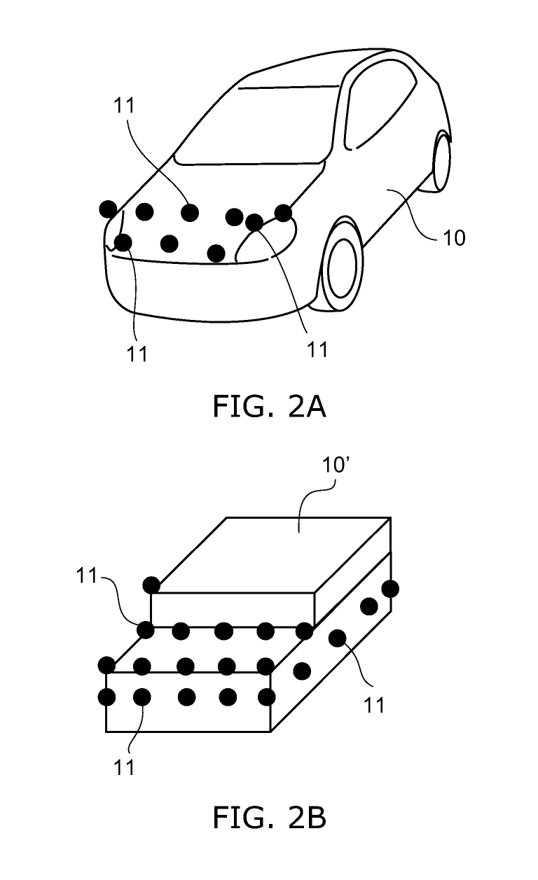

FIG. 2A is a schematic view showing a CG model of e.g. an automobile as a mobile body 10.

The endpoint setting section 102 extracts as an endpoint 11 the three-dimensional position on the mobile body coordinate system of the constituent point constituting the shape data of the mobile body 10.

The mobile body coordinate system is e.g. a coordinate system in which the origin is placed at the barycenter of the constituent points, the z-axis is directed in the forward moving direction of the mobile body 10, and the x-axis is taken on its right-hand side. The endpoint 11 represents a three-dimensional position on the surface of the mobile body 10.

In the case where the shape of the mobile body is complex, as shown in FIG. 2B, the shape data of the mobile body can be simplified. The constituent point specified in the simplified shape data of the mobile body 10′ can be used as an endpoint 11.

Here, not all the constituent points (endpoints) specified on the mobile body 10, 10′ are shown in FIGS. 2A and 2B. FIGS. 2A and 2B schematically show only part of the constituent points (endpoints) 11.

As an example of the simplification of the shape data of the mobile body, the endpoint setting section 102 can evenly transforms the shape data of the mobile body into voxels of solids, such as rectangular solids, including the shape data. Thus, an approximate shape of the mobile body can be composed of voxels including the constituent points, or the surfaces formed from a plurality of constituent points, of the shape data.

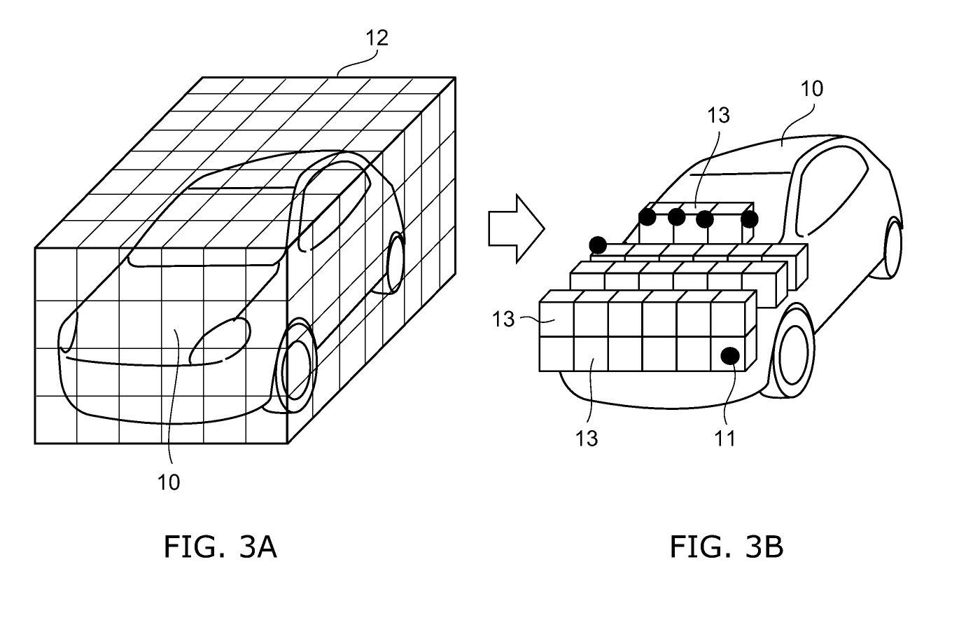

An example technique for forming voxels is as follows. As shown in FIG. 3A, the circumscribed rectangular solid 12 of the mobile body 10 is equally divided along the length, width, and height. For each divided voxel, if it includes a constituent point, the voxel is subdivided. Otherwise, the voxel is discarded. This process is repeated. This repetitive processing results in voxels 13 divided into a predetermined size as shown in FIG. 3B, and these voxels 13 can be used.

In the vertices of the voxels 13 constituting the approximate shape of this mobile body 10, the vertices not hidden by the other voxels are used as endpoints 11. Alternatively, in the center points of the surfaces of the voxels 13, the center points not hidden by the other voxels may be used as endpoints 11. Alternatively, in the barycenters of the voxels 13, the barycenters not hidden by the other voxels may be used as endpoints 11.

In forming voxels, instead of dividing the circumscribed rectangular solid 12, voxels having a prescribed size may be placed so as to include the constituent points.

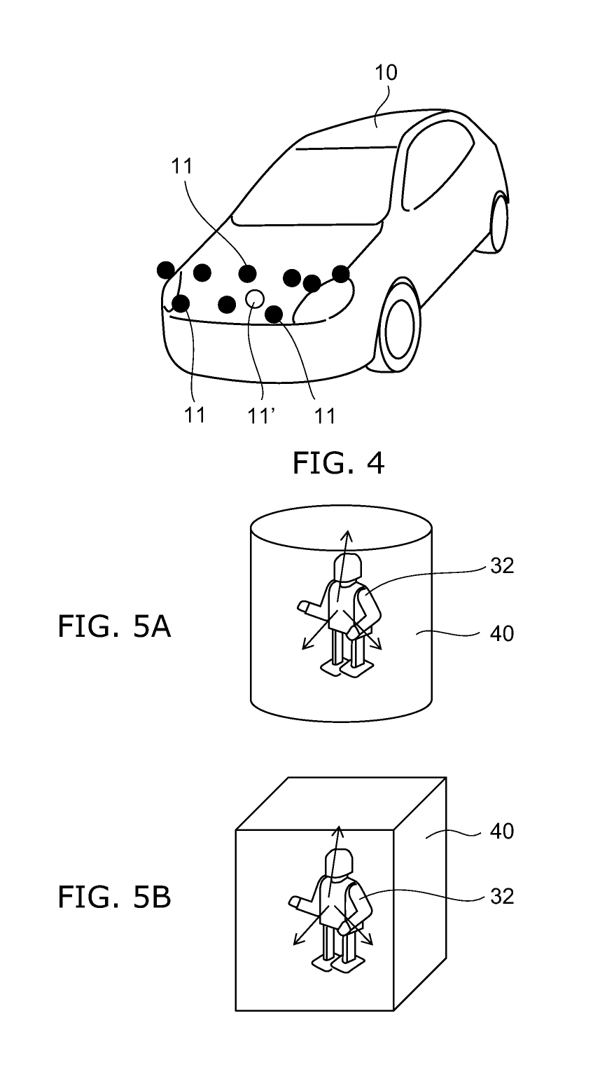

Alternatively, instead of forming voxels, the constituent points 11 indicated by black circles in FIG. 4 are clustered. The barycenter of the obtained cluster may be added as a new endpoint 11′ (indicated by a white circle in FIG. 4). With the increase of the number of specified endpoints, the position of the endpoint colliding with an object can be identified with high accuracy. Furthermore, if the number of specified endpoints is suppressed, the memory usage can be suppressed, and the processing speed can be improved.

The distance measurement section 103 is e.g. an infrared distance measurement sensor or ultrasonic sensor. The distance measurement section 103 measures the distance from the distance measurement section 103 to a surrounding object. Furthermore, the distance between the mobile body and the surrounding object can be measured using an image captured by the camera 108 and acquired by the image acquisition section 106.

The distance measurement section 103 determines the three-dimensional position on the mobile body coordinate system of the distance measurement point on the measured surrounding object from the position and posture data of the distance measurement section 103 stored in the memory section 101. Furthermore, the position of the distance measurement point is parallel displaced by the relative displacement of the endpoint with respect to the distance measurement section 103. Thus, the position of the distance measurement point on the surrounding object is determined relative to each endpoint specified on the mobile body. That is, the distance from each endpoint to the distance measurement point on the surrounding object is determined.

The constraint setting section 104 sets a measurement range based on the constraint of the movement range of the mobile body. Specifically, the constraint setting section 104 sets the aforementioned measurement range as solid data of e.g. a rectangular solid or sphere including the range in which the mobile body can move within a unit time.

FIG. 5A shows an example of the range (measurement range) 40 in which a mobile body (robot) 32 having a walking structure can move within a unit time. The range (measurement range) 40 is set by cylindrical approximation in the space above the walking surface of the mobile body (robot) 32.

FIG. 5B shows an example of the range (measurement range) 40 in which a mobile body (robot) 32 having a walking structure can move within a unit time. The range (measurement range) 40 is set by rectangular solid approximation in the space above the walking surface of the mobile body (robot) 32.

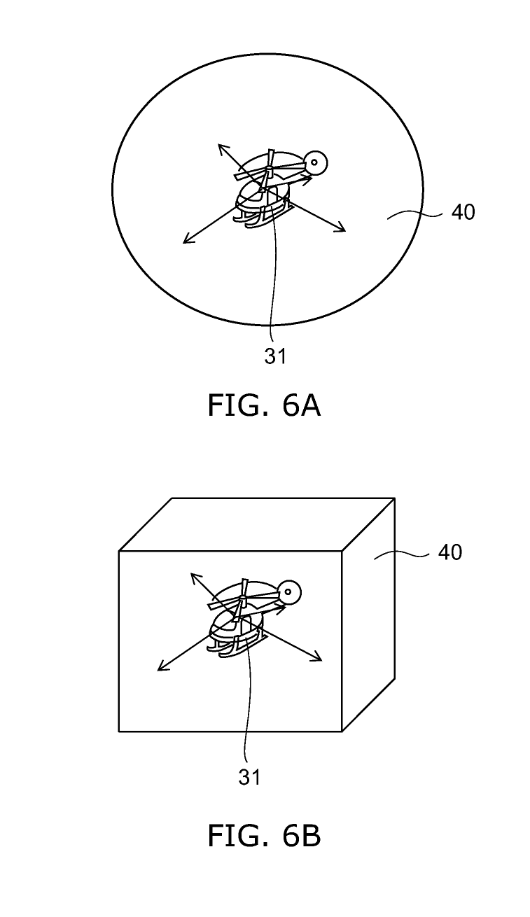

FIG. 6A shows an example of the range (measurement range) 40 in which a mobile body (flying body) 31 having a flying structure can move within a unit time. The range (measurement range) 40 is set by spherical approximation in all directions including horizontal and vertical directions of the mobile body (flying body) 31.

FIG. 6B shows an example of the range (measurement range) 40 in which a mobile body (flying body) 31 having a flying structure can move within a unit time. The range (measurement range) 40 is set by rectangular solid approximation in all directions including horizontal and vertical directions of the mobile body (flying body) 31.

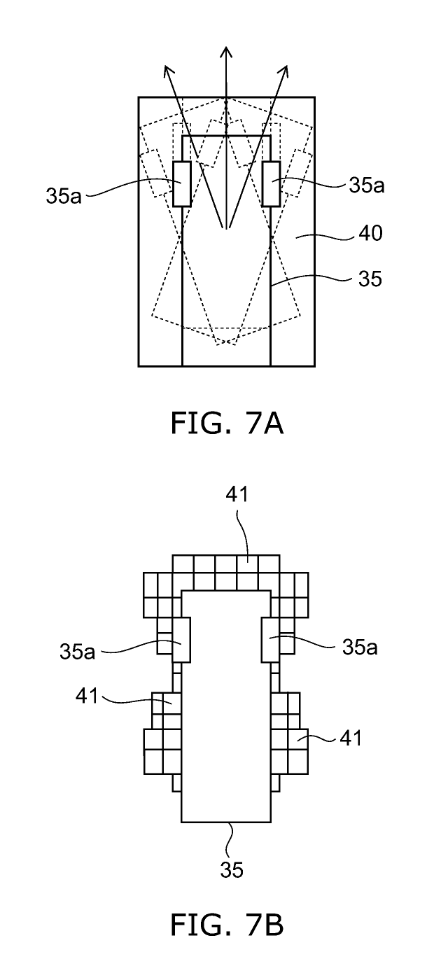

FIG. 7A shows an example of the range (measurement range) 40 in which a mobile body (automobile) 35 can move within a unit time. The range (measurement range) 40 is set by rectangular solid approximation in the space on the plane where the mobile body (automobile) 35 moves.

For instance, as shown in FIG. 7A, the mobile body 35 has a steering movement mechanism. Then, the range (measurement range) 40 in which the mobile body 35 can move per unit time is calculated using the distance between the wheels 35a, the wheel diameter of the wheel 35a, and the maximum rotational speed of the wheel 35a.

Also for the mobile body having an omnidirectional movement mechanism, walking mechanism, or flying mechanism, the range (measurement range) in which the mobile body can move per unit time can be calculated by the condition of the corresponding mechanism.

Alternatively, a movement region is obtained by calculating the movement range per unit time based on the mobile body structure and the maximum speed. The rectangular solid including the movement region is turned to voxels. The voxels including the range in which the mobile body can move within a unit time may be specified as solid data (measurement range).

For instance, FIG. 7B shows a mobile body (automobile) 35 having a steering movement mechanism. In this case, the range (measurement range) of the front, left, and right on the moving direction side is approximated by voxels 41.

The measurement point selection section 105 extracts as collision points the measurement points included in the solid data (measurement range) specified by the constraint setting section 104 from among the measurement points on the object measured by the distance measurement section 103.

More specifically, the measurement point selection section 105 acquires as collision points the measurement points on the object such that the distance from the endpoint representing the position on the surface of the mobile body to the point on the object around the mobile body falls within the measurement range specified by the constraint of the movement range of the mobile body.

There may be a plurality of pairs of an endpoint and a collision point corresponding to this endpoint. From among this plurality of pairs, the measurement point selection section 105 extracts the endpoint located at the minimum distance to the collision point as a collision expected endpoint.

Alternatively, the measurement point selection section 105 extracts the endpoint with the distance to the collision point being shorter than a predetermined threshold as a collision expected endpoint. In this case, a plurality of collision expected endpoints may be extracted. From among the plurality of collision expected endpoints, the top n collision expected endpoints with a shorter distance to the collision point may be further extracted.

The image acquisition section 106 acquires the captured image of the camera 108 mounted on the mobile body. This captured image is outputted to the display section 109 through the image processing section 107.

The camera 108 captures the surroundings of the mobile body. For instance, the camera 108 captures the front of the mobile body in the moving direction. If there is an object preventing the mobile body from moving in the field of view of the camera 108, the object is also captured.

The image processing section 107 superimposes on the image (the captured image of the camera 108) the position of the aforementioned collision point on the object extracted by the measurement point selection section 105. The position is distinguished from the portion of the object not including the collision point. This image with the collision point superimposed thereon is outputted to the display section 109.

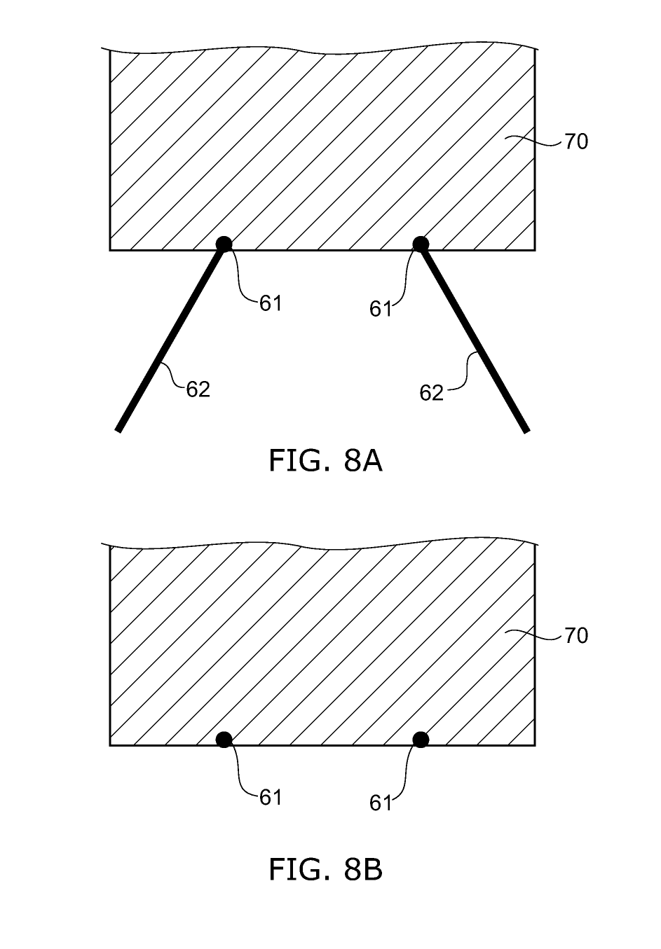

FIG. 8A schematically shows an example of the image displayed on the display section 109.

In FIG. 8A, the mobile body itself is not captured. However, the image of the front of the mobile body in the moving direction is displayed. For instance, endpoints are specified at the front left and right corners on the mobile body. The collision points 61 on the object 70 corresponding to the endpoints are displayed. For instance, the collision point 61 is displayed in a color, shape, and size easily recognizable for the operator, such as e.g. a circle of a prescribed color.

For instance, in the case of e.g. an automobile, the mobile body shape and the movement trend (behavior) are fixed to some extent. In this case, it is easily recognizable which endpoint may collide with the collision point 61 even if the endpoint is not displayed in the image. Alternatively, the endpoint may also be artificially superimposed on the image.

Furthermore, the image processing section 107 superimposes on the image a line 62 connecting the collision point 61 with the endpoint on the mobile body corresponding to this collision point 61. Even if the endpoint is not displayed, the distance perspective to the collision point 61 is visually given by displaying the line 62 connecting the endpoint with the collision point 61. Furthermore, the operating direction for advancing the mobile body can also be indicated. This facilitates collision avoidance.

Furthermore, as shown in FIG. 8B, it is also possible to display only the collision points 61 superimposed on the image for skilled operators and operators annoyed by the line 62.

The collision point 61 and the line 62 corresponding to this collision point 61 are displayed in e.g. the same color. The display color of the collision point 61 and the line 62 can be changed depending on the distance between the endpoint and the collision point 61. For instance, the collision point 61 and the line 62 corresponding to this collision point 61 can be displayed in a color corresponding to the distance, such as red for a relatively close distance from the endpoint to the collision point 61, and blue for a relatively far distance.

In FIG. 8A, the line 62 connecting the endpoint with the collision point 61 is indicated by a straight line. However, it is also possible to use other indications for associating the endpoint with the collision point 61, such as indication by a dotted line.

In the case of not displaying the mobile body itself on the image, it is sufficient to mount one camera 108 on the mobile body.

It is also possible to mount a plurality of cameras 108 on the mobile body. In this case, the image processing section 107 can create a look-down image artificially looking down at the mobile body from the image captured by the plurality of cameras 108. The look-down image can be displayed on the display section 109.

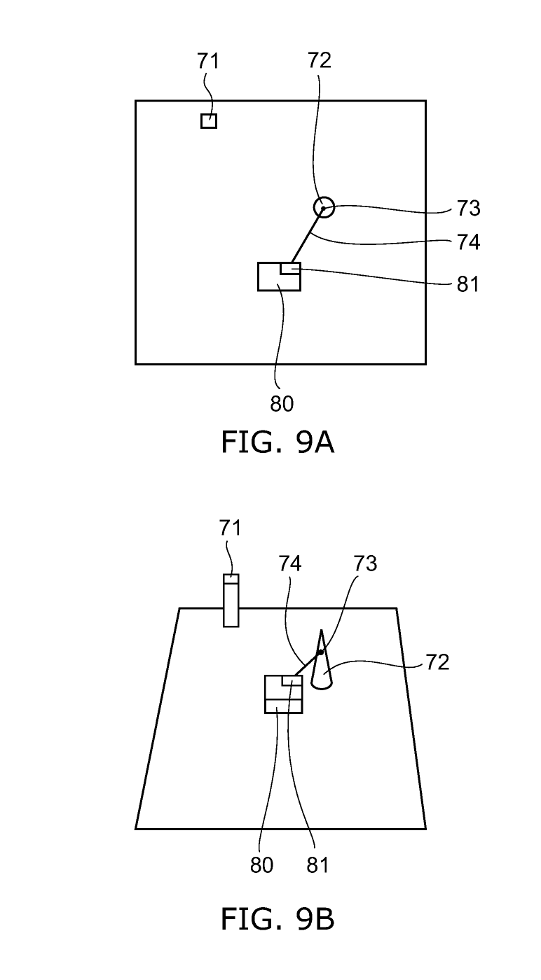

FIG. 9A schematically shows an example of the image looking down at a mobile body 80 from directly above.

FIG. 9B schematically shows an example of the image looking down at the mobile body 80 from obliquely above.

An object 71 and an object 72 around the mobile body 80 are also displayed on the look-down image shown in FIGS. 9A and 9B.

The aforementioned measurement point selection section 105 extracts e.g. the collision point 73 on the object 72 and the endpoint 81 on the mobile body 80 corresponding to this collision point 73. The image processing section 107 superimposes the collision point 73 and the endpoint 81 on the look-down image. Furthermore, the image processing section 107 superimposes a line 74 connecting the collision point 73 with the endpoint 81 on the look-down image.

The collision point 73, the endpoint 81 corresponding to this collision point 73, and the line 74 connecting the collision point 73 with the endpoint 81 are displayed in e.g. the same color. The display color of the collision point 73, the endpoint 81, and the line 74 can be changed depending on the distance between the endpoint 81 and the collision point 73. For instance, the collision point 73, the endpoint 81, and the line 74 can be displayed in a color corresponding to the distance, such as red for a relatively close distance from the endpoint 81 to the collision point 73, and blue for a relatively far distance.

In FIGS. 9A and 9B, the line 74 connecting the endpoint 81 with the collision point 73 is indicated by a straight line. However, it is also possible to use other indications for associating the endpoint 81 with the collision point 73, such as indication by a dotted line.

According to the embodiment, the collision point on the object that may constitute an obstacle to the mobile body is determined in association with the endpoint specified on the surface of the mobile body. Thus, the relationship between the mobile body and the potential collision point around the mobile body can be instantaneously ascertained. Accordingly, the mobile body operator can easily perform operation for avoiding collision between the mobile body and the object.

The memory section 101 stores a mobile body operation support program of the embodiment. The mobile body operation support device including e.g. the endpoint setting section 102, the constraint setting section 104, the measurement point selection section 105, the image acquisition section 106, and the image processing section 107 reads the program and executes the aforementioned processing (mobile body operation support method) under the instructions of the program.

The mobile body operation support program of the embodiment may be stored in a memory device not including the memory section 101. The mobile body operation support program of the embodiment is not limited to being stored in a memory device installed on the mobile body or the controller-side unit. The program may be stored in a portable disk recording medium or semiconductor memory.

The endpoint specified by the endpoint setting section 102 may be stored in the memory section 101 as data specific to the mobile body. Alternatively, in the case of e.g. a remote-controlled robot, the shape data of the mobile body is changed when the robot holds and lifts a thing. This changes the endpoints on the mobile body surface that may collide with the surrounding object. That is, the thing held by the robot is also included in part of the mobile body. In such cases, the endpoint setting section 102 updates the endpoints specified previously based on the shape of the robot itself. Thus, the endpoint setting section 102 can respond to the change of the shape data of the mobile body.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A mobile body operation support device comprising:
a measurement point selection section acquiring a point on an object around a mobile body when distance from an endpoint representing a position on a surface of the mobile body to the point on the object falls within a measurement range setting from a constraint of a movement range of the mobile body.

2. The device according to claim 1, wherein
the endpoint is setting in a plurality, and
the measurement point selection section extracts an endpoint located at a minimum distance to the point as a collision expected endpoint.

3. The device according to claim 1, wherein
the endpoint is setting in a plurality, and
the measurement point selection section extracts an endpoint with the distance to the point being shorter than a threshold as a collision expected endpoint.

4. The device according to claim 1, further comprising:
an image processing section superimposing a position of the point on an image of the object captured by a camera mounted on the mobile body, the position of the point being distinguished from a portion of the object not including the point.

5. The device according to claim 4, wherein the image processing section superimposes a line connecting the point with the endpoint corresponding to the point on the image.

6. The device according to claim 4, wherein the image processing section creates a look-down image artificially looking down at the mobile body from the image captured by the camera, and superimposes the endpoint corresponding to the point on the mobile body on the look-down image.

7. The device according to claim 6, wherein the image processing section superimposes a line connecting the point with the endpoint on the look-down image.

8. The device according to claim 4, wherein the image processing section changes color of the point on the image depending on the distance to the endpoint.

9. The device according to claim 5, wherein the image processing section changes color of the line on the image depending on the distance between the point and the endpoint.

10. The device according to claim 7, wherein the image processing section changes color of the line on the look-down image depending on the distance between the point and the endpoint.

11. The device according to claim 6, wherein the image processing section changes color of the point on the look-down image depending on the distance between the point and the endpoint.

12. A mobile body operation support method comprising:
specifying a point on an object around a mobile body when distance from an endpoint representing a position on a surface of the mobile body to the point on the object falls within a measurement range setting from a constraint of a movement range of the mobile body.

13. The method according to claim 12, wherein the endpoint is setting in a plurality, and from among the plurality of endpoints, an endpoint located at a minimum distance to the point is extracted as a collision expected endpoint.

14. The method according to claim 12, wherein the endpoint is setting in a plurality, and from among the plurality of endpoints, an endpoint with the distance to the point being shorter than a threshold is extracted as a collision expected endpoint.

15. The method according to claim 12, wherein a position of the point is superimposed on an image of the object captured by a camera mounted on the mobile body, the position of the point being distinguished from a portion of the object not including the point.

16. The method according to claim 15, wherein a look-down image artificially looking down at the mobile body is created from the image captured by the camera, and the endpoint corresponding to the point is superimposed on the mobile body on the look-down image.

17. The method according to claim 15, wherein color of the point on the image is changed depending on the distance to the endpoint.

18. The method according to claim 16, wherein color of the point on the look-down image is changed depending on the distance between the point and the endpoint.

19. The method according to claim 15, wherein a line connecting the point with the endpoint corresponding to the point is superimposed on the image.

20. A computer readable non-transitory storage medium comprising a mobile body operation support program,
the program causing a computer to execute processing configured to acquire a point on an object around a mobile body when distance from an endpoint representing a position on a surface of the mobile body to the point on the object falls within a measurement range setting from a constraint of a movement range of the mobile body.
